(19) United States
(12) Patent Application Publication
(10) Pub. No.: US 2020/0074098 A1
(43) Pub. Date: Mar. 5, 2020

(54) MULTI-LAYER CYBERSECURITY SYSTEM FOR RESTRICTING DATA ACCESS

(71) Applicant: Honeywell International Inc., Morris Plains, NJ (US)

(72) Inventors: Bassam M. MASRI, Scottsdale, AZ (US); Wayne TEWALT, Anthem, AZ (US); Benjamin J. SLOTTER, Glendale, AZ (US)

(73) Assignee: Honeywell International Inc.

(21) Appl. No.: 16/117,787

(22) Filed: Aug. 30, 2018

(51) Int. Cl. G06F 21/62; G06F 21/31

(52) U.S. Cl. CPC G06F 21/6218; G06F 21/31

(57) ABSTRACT

Systems and methods are disclosed for restricting data access using a multi-layer cybersecurity system. A first computer system, executing a first set of instructions written in a first programming language to operate a first layer, receives a data access request from a requesting device, determines whether a first set of keys are matched by the data access request, and declines the data access request if the first set of keys are not matched. If the first set of keys are matched, a second computer system, executing a second set of instructions written in a second programming language, receives the data access request from the first security layer, determines whether a second set of keys are matched by the data access request, and declines the data access request if the second set of keys are not matched. If the second set of keys are matched, the data access request is granted.

### TECHNICAL FIELD

The present disclosure relates to methods and systems for cybersecurity. More particularly, the present disclosure relates to methods and systems for authenticating data or data access requests targeted towards systems storing critical data, using a highly customizable multi-layer cyber lock mechanism.

### BACKGROUND

With the proliferation of Internet of Things (IoT) (i.e., connected systems) in today's world, billions of machines, devices, and systems around the world are connected, collecting and sharing data. Connected systems control electrical grid switches and public water systems, monitor vehicle condition and traffic, track medical histories of patients, automate homes and consumer devices, and much more. This trend has sparked a security concern with businesses and consumers, as prevalence of high-value and safety-critical systems make them a target for a variety of cyber-attacks and intrusions. Despite the increasing concern over cybersecurity, the security efforts for the connected systems have been suboptimal. For instance, security software is sometimes flawed and basic hardware security features can be overlooked. Encryption and authentication methods are sometimes outdated and/or duplicated across devices.

Therefore, there is a need for an enhanced security system for connected systems and devices. In particular, it may be desirable to have a highly flexible system that can serve a variety of markets and that can provide robust protection from both hardware and software domains.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

One embodiment provides a computer-implemented method for restricting data access using a multi-layer cybersecurity system comprising a first computer system and a second computer system, the computer-implemented method comprising: by the first computer system executing a first set of instructions to operate a first layer, receiving a data access request from a requesting device, determining whether a first set of keys are matched by the data access request, and declining the data access request and sending a notification to a user device based on determining the first set of keys are not matched; and by the second computer system executing a second set of instructions written in a programming language different from that of the first set of instructions to operate a second security layer, receiving the data access request from the first security layer based on the first computer system determining the first set of keys are matched, determining whether a second set of keys are matched by the data access request, and declining the data access request and sending a notification to the user device based on determining the second set of keys are not matched.

One embodiment provides a multi-layer cybersecurity system for restricting data access. The system may comprise a first computer system executing a first set of instructions to operate a first security layer, the first set of instructions causing the first computer system to: receive a data access request from a requesting device; determine whether a first set of keys are matched by the data access request; and decline the data access request and send a notification to a user device based on determining the first set of keys are not matched; and a second computer system executing a second set of instructions written in a programming language different from that of the first set of instructions to operate a second security layer, the second set of instructions causing the second computer system to: receive the data access request from the first security layer based on the first computer system determining the first set of keys are matched; determine whether a second set of keys are matched by the data access request; and decline the data access request and sending a notification to the user device based on determining the second set of keys are not matched.

One embodiment provides a non-transitory computer readable medium for restricting data access using a multi-layer cybersecurity system comprising a first computer system and a second computer system. The non-transitory computer readable medium may store instructions that, when executed by one or more processors, cause the one or more processors to perform a method comprising: by the first computer system executing a first set of instructions to operate a first layer, receiving a data access request from a requesting device, determining whether a first set of keys are matched by the data access request, and declining the data access request and sending a notification to a user device based on determining the first set of keys are not matched; and by the second computer system executing a second set of instructions written in a programming language different from that of the first set of instructions to operate a second security layer, receiving the data access request from the first security layer based on the first computer system determining the first set of keys are matched, determining whether a second set of keys are matched by the data access request, and declining the data access request and sending a notification to the user device based on determining the second set of keys are not matched.

### BRIEF DESCRIPTION OF THE DRAWINGS

Embodiments of the invention will now be described, by way of example only, with reference to the accompanying drawings in which:

FIG. 1 illustrates an exemplary embodiment of a data security system employing a multi-layer lock system consistent with embodiments of the present disclosure.

FIG. 2 illustrates an exemplary embodiment of the data security system shown in FIG. 1, in the context of an aircraft/avionics environment.

FIG. 3 is a block diagram illustrating exemplary components of the multi-layer lock system consistent with embodiments of the present disclosure.

FIG. 4 is a concept diagram illustrating an exemplary design of the multi-layer lock system consistent with embodiments of the present disclosure.

FIG. 5 is a block diagram illustrating exemplary components of the multi-layer lock system designed in accordance with the concept diagram of FIG. 4.

FIG. 6 is a flowchart illustrating an exemplary method of performing layered authentication processes by the multi-layer lock system depicted in FIG. 5.

FIG. 7 is a concept diagram illustrating another exemplary design of the multi-layer lock system consistent with embodiments of the present disclosure.

FIG. 8 is a block diagram illustrating exemplary components of the multi-layer lock system designed in accordance with the concept diagram of FIG. 7.

FIG. 9 is a flowchart illustrating an exemplary method of performing layered authentication processes by the multi-layer lock system depicted in FIG. 8.

### DETAILED DESCRIPTION

The following embodiments describe systems and methods for authenticating data or data access requests targeted towards systems storing critical data, using a highly customizable multi-layer cyber lock mechanism.

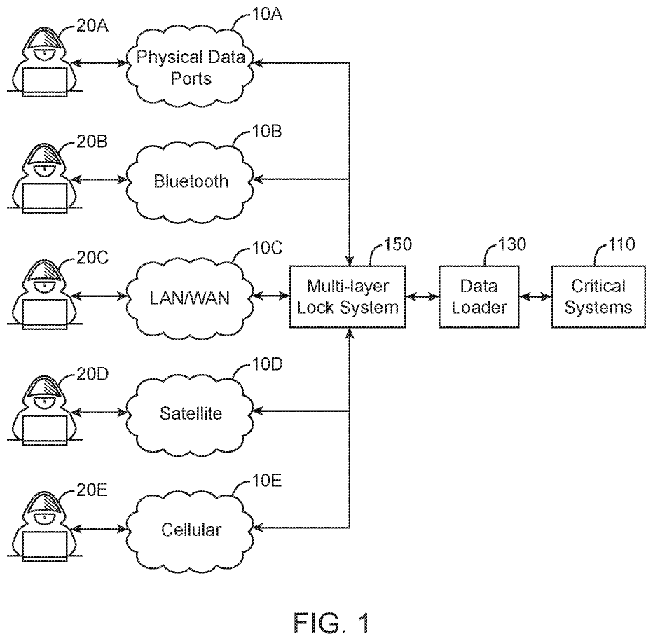

Multi-layer lock system of the present disclosure (i.e., multi-layer lock system 150 depicted in FIGS. 1-3, 5, and 7) may be a multi-layered cybersecurity system that prevents unauthorized electronic interaction with connected critical electronic systems. Software and hardware of the multi-layer lock system 150 may be highly configurable and customizable, comprising multiple independent, diverse, and isolated security measures implemented by software as well as hardware, to form a layered protection. To maintain dissimilarity between security measures, each security measure (i.e., each layer) may use a different processor with a different processing architecture, comprising its own independent program storage and RAM, and may use a different programming language and may be developed independently of any other security measure. Multi-layer lock system 150 may be built as a standalone portable device, a standalone Line Replaceable Unit (LRU), or may be integrated into network or system interface components, such as, e.g., data loaders, routers, etc. As such, different versions of multi-layer lock system 150 may be constructed, which will support different multi-compatible interfaces (e.g., Universal Serial Bus (USB), ARINC 429, ARINC 615A, Wi-Fi, cellular, etc., or a combination thereof) connected with the critical electronic systems. In particular, multi-layer lock system 150 implemented as a standalone portable device may enable the security solution of the present disclosure to be used across multiple end point products which may or may not be interconnected. For example, in the context of an aircraft, the standalone portable device may ensure secure access to both cockpit avionics and engine maintenance ports during aircraft servicing.

The multi-layer lock system 150 may be provided as a lower cost security system (i.e., as a standalone portable device), utilizing readily-available hardware and software implementations. Also, the multi-layer lock system 150 may be provided as a higher value, higher cost security system, utilizing more sophisticated and customized software/hardware implementations. Therefore, the highly customizable nature of the multi-layer lock system 150 may enable the security system to be tailored to multiple markets (e.g., aerospace, connected vehicle, industrial and facility management, traffic control, corporate/commercial/residential, medical, etc.).

Subject matter will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended reflect or indicate that the embodiment(s) is/are “example” embodiment(s). Subject matter be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

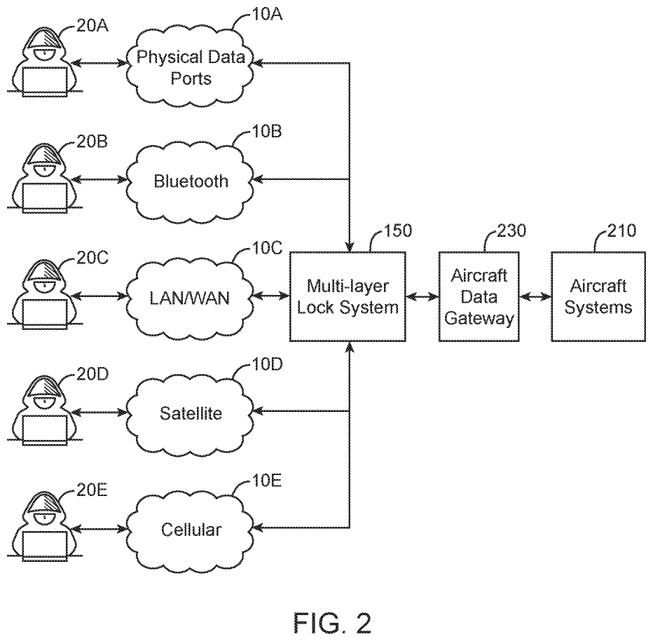

Referring now to the appended drawings, FIG. 1 shows an exemplary embodiment of a data security system employing multi-layer lock system 150 of the present disclosure. In general, FIG. 1 depicts critical system(s) 110, a data loader 130, a multi-layer lock system 150, user devices 20A-20E, and communication modes 10A-10E. FIG. 2 shows an exemplary embodiment of the data security system employing the multi-layer lock system 150, implemented for an aircraft/avionics environment. In general, FIG. 2 depicts aircraft system(s) 210, an aircraft gateway 230, a multi-layer lock system 150, user devices 20A-20E, and communication modes 10A-10E. In the discussion below, reference will be made to both FIG. 1 and FIG. 2.

In FIG. 1, critical system(s) 110 may be computer system(s) or storage device(s) that store critical data that need to be protected against unauthorized access, which may include unauthorized viewing, altering, deleting, downloading, etc. of the stored data. Examples of critical systems(s) 110 may include computer system(s) or storage device(s) implemented in manned or unmanned vehicles, banking and electronic commerce systems, industrial computer systems, facility management systems, traffic control and management systems, corporate computer systems, medical database systems, commercial and residential computer systems, personal computer systems, etc. For instance, critical system(s) 110 that are implemented in an aircraft may be aircraft system(s) 210 illustrated in FIG. 2. Examples of aircraft system(s) 210 may include, but are not limited to, a propulsion system, a vehicle control system, an environmental system, a navigation system, a flight management system, a communication system, and a maintenance system. Each of the aircraft system(s) 210 may store data that is critical to safe and efficient operation of the aircraft, and may thus need additional, more robust protection against unauthorized access.

Data loader 130 may be a computer system or a device coupled to the critical system(s) 110 via wired or wireless connection, to load or retrieve critical data from the critical system(s), and to transmit the critical data to other systems or devices. For instance, data loader 130 that is implemented on an aircraft may be an aircraft data gateway 230 (e.g., ADG-300, ADG-400, etc.). Aircraft data gateway 230 may load data from aircraft system(s) 210 (i.e., may enable connected data loading by integrating all sources of data on the aircraft) and transmit the data on and off the aircraft in real time. Aircraft data gateway 230 (i.e., data loader 130) may also be equipped with an encryption mechanism to keep the data secure.

Multi-layer lock system 150 may be a computer system or a device coupled to the data loader 130 to monitor and authenticate data and data access requests targeted for the data loader 130 and/or the critical system(s) 110. In one embodiment, the multi-layer lock system 150 may be coupled to the data loader 130 via wireless or wired connection, such as, e.g., Universal Serial Bus (USB), data bus, Wi-Fi, cable, Ethernet, or any suitable connection mechanism now-known or later-developed. In some embodiments, the multi-layer lock system 150 may be implemented on the data loader 130, meaning the multi-layer lock system 150 may be integrated into the data loader 130, instead of being a separate system or a device that is coupled to the data loader 130 as discussed above.

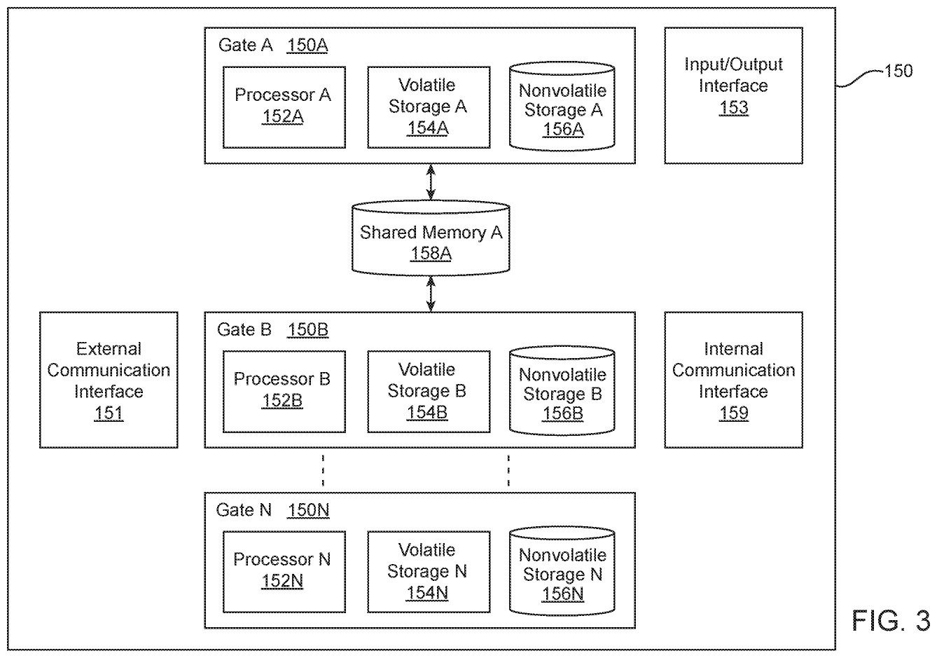

It should be noted that, although data loader 130 and critical system(s) 110 are depicted as separate components/devices in FIG. 1, data loader 130 and critical system(s) 110 may be implemented as a single component/device. For instance, such a single component/device may comprise a module configured to retrieve/store critical data (analogous to data loader 130) in an internal storage (analogous to critical system(s) 110). Therefore, the multi-layer lock system 150 may be coupled to such a single component/device. For example, such a single component/device comprising both data loader 130 and critical system(s) 110 may be a personal computer system storing private information, and the multi-layer lock system 150 may be a portable device coupled to the personal computer system via USB or Ethernet connection. However, in addition to the USB or Ethernet connection, the multi-layer lock system 150 may connect to the personal computer system (as well as other systems or devices) using various communication paths now-known or later-developed, as explained in greater detail in the following sections describing communication interfaces 151 and 159 in FIG. 3.

User devices 20A-20E may be computer systems or devices that may be in communication with the data loader 130 and/or the critical system(s) 110 via various types of communication modes 10A-10E, to request and receive critical data from the critical system(s) 110. In the present disclosure, the user devices 20A-20E may not necessarily be directly coupled to either the data loader 130 or the critical system(s) 110. As illustrated in FIG. 1, the multi-layer lock system 150 may be installed between the data loader 130 and the user devices 20A-20E. Therefore, the user devices 20A-20E may be in communication with the data loader 130 and/or the critical systems 110 indirectly through the multi-layer lock system 150. As illustrated in FIGS. 1-2, the user devices 20A-20E may use various types of communication modes to connect to the multi-layer lock system 150, such as, e.g., physical data ports (e.g., USB, etc.), Bluetooth, LAN/WAN (wireless or wired (e.g., Ethernet, cable, etc.)), cellular connection, satellite connection, etc. The multi-layer lock system 150 may monitor, analyze, and/or authenticate (i.e., validate) incoming data and/or data access requests transmitted from the user devices 20A-20E, thus protecting the data loader 130 and the critical system(s) 110 from unauthorized access or intrusion. Incoming data and/or data access request from the user devices 20A-20E may include authentication data (e.g., user data used for authentication, device data used for authentication, keys generated based on the user/device data, etc.), data access request with or without such authentication data appended thereon, data to be stored in the critical system(s) 110, any other data that may be monitored, analyzed, and/or authenticated by the multi-layer lock system 150, or any combination thereof. The authentication process will be discussed in greater detail in the following sections.

FIG. 3 is a block diagram illustrating exemplary components of the multi-layer lock system 150 of the present disclosure. In general, FIG. 3 depicts multiple gates (e.g., Gate A 150A, Gate B 150B, . . . Gate N 150N), processors, volatile storages, and nonvolatile storages implemented in the multiple gates (e.g., Processor A 152A, Volatile Storage A 154A, and Nonvolatile Storage A 156A implemented in Gate A 150A, Processor B 152B, Volatile Storage B 154B, and Nonvolatile Storage B 156B implemented in Gate B 150B, and Processor N 152N, Volatile Storage N 154N, and Nonvolatile Storage N 156N implemented in Gate N 150N), Shared Memory 158, External Communication Interface 151, and Internal Communication Interface 159.

Multi-layer lock system 150 may include External Communication Interface 151. External Communication Interface 151 may allow data to be transmitted between the user devices 20A-20E and the multi-layer lock system 150. Data may be transmitted in the form of signals, which may be electronic, electromagnetic, optical, or other signals capable of being received by External Communication Interface 151. These signals may be provided to External Communication Interface 151 via a communication mode of the multi-layer lock system 150 discussed above, such as, e.g., physical data ports, Bluetooth, LAN/WAN (wireless or wired (e.g., Ethernet, cable, etc.)), cellular connection, satellite connection, etc.

Multi-layer lock system 150 may also include Internal Communication Interface 159. Similar to External Communication Interface 151, Internal Communication Interface 159 enables data transmission between the multi-layer lock system 150 and an internal component, such as data loader 130 or critical system(s) 110. Internal Communication Interface 159 may allow data and data access requests authenticated by the multi-layer lock system 150 to be transmitted to the data loader 130 and/or the critical system(s) 110 (i.e., to access, retrieve, or modify data stored in the critical system(s) 110). Internal Communication Interface 159 may also receive data retrieved/loaded by the data loader 130. Data transmission occurring between the communication interface 159 and the data loader 130 may be in the form of signals discussed above with respect to External Communication Interface 151. Further, as alluded to above, if the multi-layer lock system 150 is implemented in the data loader 130 (i.e., as a component of the data loader 130, instead of being a separate, stand-alone system/device), the data transmission between the communication interface 159 and the data loader 130 may be through a data communication infrastructure of the data loader 130, such as, e.g., a bus, message queue, network, or multi-core message-passing scheme.

Although External Communication Interface 151 and Internal Communication Interface 159 are illustrated as separate components of the multi-layer lock system 150, these communication interfaces may be a single component, managing all incoming and outgoing data communications regardless of origin or designation. Such communication interface, as discussed above, may receive and transmit data in the form of signals via various communication modes (e.g., physical data ports, Bluetooth, LAN/WAN (wireless or wired (e.g., Ethernet, cable, etc.)), cellular connection, satellite connection, etc.). Software (e.g., cybersecurity software such as, e.g., anti-hacking, anti-virus, anti-malware, etc.) or firmware for each security measure (i.e., each layer or gate) of the multi-layer lock system 15 may be downloaded and installed via the communication interface. Further, a user of the multi-layer lock system 150 may use a mobile device (e.g., cellular phone, tablet, laptop, portable device, etc.) to connect to the multi-layer lock system 150 via the communication interface, and may control settings and configurations of the multi-layer lock system 150, as well as view status, results, and notifications generated by the multi-layer lock system 150 through the mobile device. Furthermore, notifications generated by the multi-layer lock system 150 may also be sent to the user device that generated the data or data access request (i.e., party requesting access) via the communication interface.

As alluded to above, the multi-layer lock system 150 may include multiple gates (e.g., Gate A 150A, Gate B 150B, . . . Gate N 150N), each comprising at least one processor, at least one volatile storage (e.g., memory such as RAM), and at least one nonvolatile storage (e.g., ROM and/or hard drive). Each gate may be configured to perform a security measure on the data or data access requests originated from the user devices 10A-10E. Notably, each gate may include at least one unique processor with a unique processing architecture (e.g., unique CPU chip, manufactured by a vendor that is different from the vendors of the processors of the other gates), and may include at least one volatile storage and at least one nonvolatile storage connected therewith. Further, each gate may comprise unique cybersecurity (e.g., anti-hacking, anti-virus, anti-malware, etc.) software or computer instructions stored on the nonvolatile storage implemented therein, the software or computer instructions being configured to authenticate the data or data access requests received from the user devices 10A-10E. Each unique cybersecurity software or computer instructions for the corresponding gate may be developed independently from those of the other gates. For instance, cybersecurity software or computer instructions for one gate may be written in a computer programming language that is different from those of the other gates in the multi-layer lock system 150. In some embodiments, instead of being written in different computer programming languages, the software or computer instructions for the gates may be written using different coding schemes (i.e., different coding designs). In some embodiments, the software or computer instructions for the gates may be written using different computer programming languages and different coding schemes. Each gate may also comprise a unique firmware installed thereon.

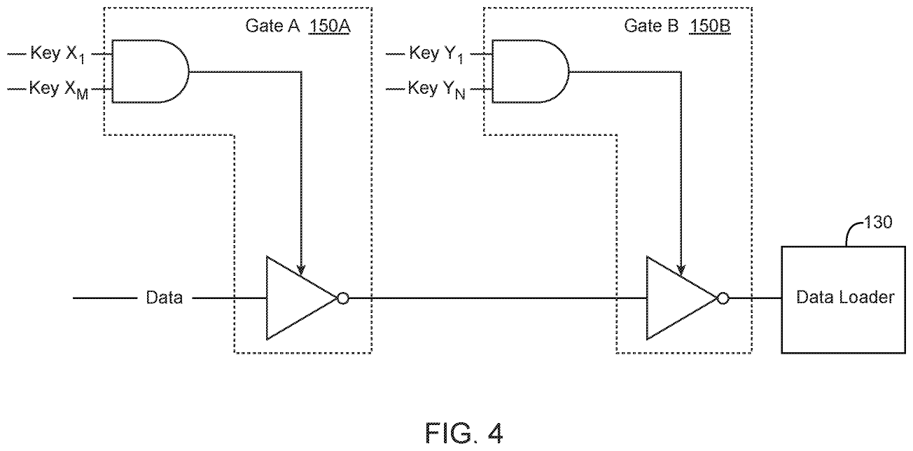

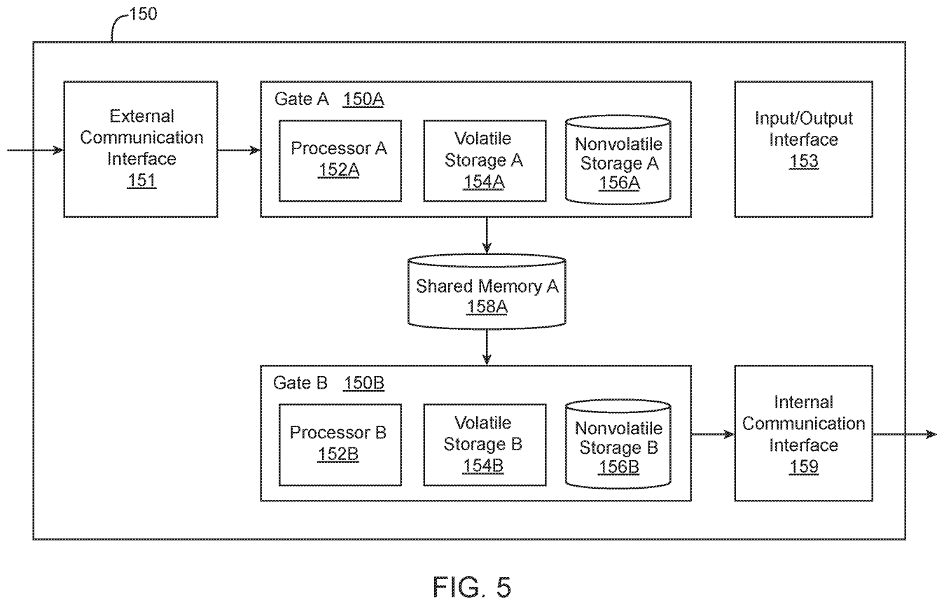

Multi-layer lock system 150 may include any number of gates (e.g., two or more gates preferably). The gates may be arranged in a variety of ways. Further, arrangement of the gates may be customizable, depending on the needs of the users/consumers of the multi-layer lock system 150. For example, as will be described in greater detail in the following sections with reference to FIGS. 4-5, one gate may be placed in series after another, such that data or data access request may first go through an authentication process by one of the gates (i.e., authenticated by a first gate), then once the data or data access request is authenticated by the first gate (i.e., once the data or data access request “unlocks” the first gate), the data or data access request may then go through another authentication process by a second gate. By this arrangement, multiple authentication processes may be carried out in a consecutive/serialized manner, and an intruder (e.g., a hacker) attempting to gain unauthorized access to the critical system(s) 110 will have to unlock a series of gates, each gate comprising a unique cybersecurity software or computer instructions executed by a unique processor. In summary, multiple gates utilizing dissimilar hardware and software implementations may be resident in the multi-layer lock system 150, providing layered or tiered security measures to more vigorously protect the data loader 130 and the critical systems 110 from unauthorized cyber intrusions.

Data or a data access request that is authenticated by the first gate may be directly transmitted to the second gate through a data communication infrastructure of the multi-layer lock system 150, such as, e.g., a bus, message queue, network, or multi-core message-passing scheme. In another embodiment, the data or data access request authenticated by the first gate may not be directly transmitted to the second gate through the data communication infrastructure. Instead, the data or data access request authenticated by the first gate may be transmitted to a shared memory (e.g., Shared Memory A 158A in FIG. 3), which may be situated (whether virtually or via connection) between the first gate and the second gate, and may be coupled to both the first gate and the second gate. Once the data or data access request authenticated by the first gate is transmitted and stored in the shared memory, the second gate may retrieve the data or data access request from the shared memory and perform a second authentication process. Further, the data or data access request stored in the shared memory may be scanned, sanitized, and checked for integrity before being passed through the subsequent gate. In some embodiments, an authentication failure (e.g., failure to provide matching keys) may cause the multi-layer lock system 150 to clear the associated shared memory, which will act as a deterrent by preventing the potential hacker or intruder from finding the cause or the type of the failure. In one embodiment, the shared memory may not include any executable program thereon. However, in another embodiment, the shared memory may include one or more executable programs. It should be noted that, although FIG. 3 shows a single shared memory (Shared Memory A 158A) placed between two gates, multiple shared memories may be placed between two gates to perform the above-described functions.

With renewed reference to FIG. 3, multi-layer lock system 150 also may include Input/Output Interface 350 to connect with input and output devices such as keyboards, mice, touchscreens, monitors, displays, USB, flash memory, etc. Software (e.g., cybersecurity software such as, e.g., anti-hacking, anti-virus, anti-malware, etc.) or firmware for each security measure (i.e., each layer or gate) of the multi-layer lock system 150 may be received and installed via input interface. Further, notifications indicating success or failure of the overall authentication process of the multi-layer lock system 150 may be displayed on monitors or display devices connected via output interface. Further, the monitors or display devices may display configurations and settings, as well as the status, results, and notifications generated by the multi-layer lock system 150. Furthermore, the multi-layer lock system 150 may comprise a built-in Liquid Crystal Display (LCD) touch screen that displays the notifications, authentication status and results, and control and configuration settings, and may receive user input via the touch screen (e.g., configuration and setting selections, receipt of notification acknowledgments, etc.).

FIG. 4 is a concept diagram illustrating an exemplary design of the multi-layer lock system 150. In general, FIG. 4 depicts multiples gates (Gate A 150A and Gate B 150B) arranged in a serial manner. As illustrated in FIG. 4, each gate may be equipped with a lock mechanism that can be unlocked by one or more keys. For more robust protection, each gate may require two or more keys to be provided by the data or data access request originated from a user (i.e., each gate requires the user or the user device requesting access (i.e., requesting device) to provide keys that match the keys of the gate). Keys implemented by the lock mechanism of each gate (i.e., control keys) may be dissimilar multi-factor authentication keys that may utilize dissimilar means of authentication. Such means of authentication may be either hardware or software-based (i.e., physical or electronic). For example, means of authentication may include passwords, smart cards, physical keys, electronic keys, digital tokens, digital certificates, digital/handwritten signatures, device identifiers, IP addresses, biometric information such as voice prints, photos, fingerprints, facial scan, retinal scan, etc., and any now-known or later-developed means of authentication. Means of authentication may be collected at user devices 20A-20E, and keys may be generated based on the collected information. Keys may then be transmitted to the multi-layer system 150 as part of the data or data access request issued by the user device, and compared with the control keys of the gates of the multi-layer lock system 150. Alternatively, the collected information may be directly transmitted to the multi-layer lock system 150 as part of the data or data access request issued by the user device, converted to keys at the multi-layer lock system 150, and then compared with the control keys of the gates. As will be known to a person of ordinary skill in the art, each key may be generated based on a single element of collected information, or a combination of collected information.

Referring back to FIG. 4, each gate may require two keys for the data or data access request to pass through. For instance, Gate A 150A may include a lock mechanism that comprises Key X₁ and Key X_{M} for authentication. In other words, Gate A 150A requires keys that match Key X₁ and Key X_{M} to unlock the gate (i.e., to unlock the lock mechanism of the gate). Notably, in FIG. 4, Key X₁ and Key X_{M} of Gate A 150A are shown as being ANDed together, meaning keys matching both Key X₁ and Key X_{M} are required to unlock the gate. Therefore, any data or data access request that needs to go through Gate A 150A (or any user that requested such data access) must include/provide keys that match Key X₁ and Key X_{M}. If the data or data access request does not include the matching keys and fails the authentication process of Gate A 150A, a notification indicating the failure or the intrusion attempt may be sent to a user (i.e., to a device of that user) of the multi-layer lock system 150, and/or to the user device that generated the data or data access request (i.e., requesting device), and the authentication process is terminated.

If the keys matching both Key X₁ and Key X_{M} are provided, the data or data access request may be transmitted to the next gate, Gate B 150B. Gate B 150B may include a lock mechanism that comprises a combination of keys that are different from the combination of keys at Gate A 150A. For instance, Gate B 150B may include a lock mechanism that comprises Key Y₁ and Key X_{N}. Again, Key Y₁ and Key X_{N} of Gate B 150B may be ANDed together, requiring keys matching both Key Y₁ and Key X_{N} to unlock the gate. If the data or data access request does not include the matching keys and fails the authentication process of Gate B 150B, a notification indicating the failure or the intrusion attempt may be sent to a user (i.e., to a device of that user) of the multi-layer lock system 150 and/or to the user device that generated the data or data access request (i.e., requesting device), and the authentication process is terminated. If the data or data access request (or the user that requested such data access) includes/provides the matching keys, the data or data access request may be passed through Gate B 150B and be transmitted to data loader 130. In some embodiments, a notification indicating successful authentication or access granted may be sent to the user (i.e., to a device of that user) of the multi-layer lock system 150 and/or to the user device that generated the data or data access request (i.e., requesting device).

FIG. 5 is a block diagram illustrating exemplary components of the multi-layer lock system 150 designed in accordance with the concept diagram of FIG. 4. In general, FIG. 5 depicts External Communication Interface 151, Gate A 150A, Shared Memory A 158A, Gate B 150B, and Internal Communication Interface 159. The arrows in FIG. 5 indicate the flow and/or direction of the data or data access request received at the multi-layer lock system 150, along the multiple components embodied therein. First, the data or data access request from a user device (e.g., any of the user devices 20A-20E in FIG. 1) may be received by External Communication Interface 151. The received data or data access request may then be transmitted/forwarded to Gate A 150A to initiate a set of authentication processes. Nonvolatile Storage A 156A may store the cybersecurity software or computer instructions corresponding to Gate A 150A (i.e., cybersecurity software or computer instructions implementing the Gate A 150A design illustrated in FIG. 4), which may be loaded and executed by Processor A 152A and Volatile Storage A 154A. Nonvolatile Storage A 156A may further store Key X₁ and Key X_{M} discussed above with reference to FIG. 4. Using Processor A 152A, Volatile Storage A 154A, and Nonvolatile Storage A 145A, the received data or data access request may be analyzed to determine whether keys matching Key X₁ and Key X_{M} are present. If keys matching both Key X₁ and Key X_{M} are not present (e.g., if there is no match, or if there is only one match), Processor A 152A may issue and transmit a notification to a user (i.e., to a device of that user) of the multi-layer lock system 150, via a display coupled to or in communication with the multi-layer lock system 150. Processor A 152A may also send the notification via email, text-messaging, or any other communication means now-known or later-developed. As alluded to above, the notification may indicate to the user the authentication failure or the intrusion attempt. Further, the notification indicating the authentication failure may also be sent to the user device that generated the data or data access request (i.e., requesting device).

If keys matching both Key X₁ and Key X_{M} are present, the data or data access request may be transmitted and stored in Shared Memory A 158A, where the data or data access request may be scanned, sanitized, and checked for integrity before being transmitted to Gate B 150B. In another embodiment, Shared Memory A 158A may not be implemented and the data or data access request may be transmitted directly to Gate B 150B. In yet another embodiment, Shared Memory A 158A may be present but the data or data access request may bypass Shared Memory A 158A and may be transmitted directly to Gate B 150B. Once the data or data access request is received at Gate B 150B, cybersecurity software or computer instructions corresponding to Gate B 150B (i.e., cybersecurity software or computer instructions implementing the Gate B 150B design illustrated in FIG. 4) stored in Nonvolatile Storage B 154B may be loaded and executed by Processor B 152B and Volatile Storage B 154B. Nonvolatile Storage B 154B may further store Key Y₁ and Key X_{N} discussed above with reference to FIG. 4. Using Processor B 150B, Volatile Storage B 154B, and Nonvolatile Storage B 156B, the received data or data access request may be analyzed to determine whether keys matching Key Y₁ and Key X_{N} are present. If keys matching both Key Y₁ and Key X_{N} are not present (e.g., if there is no match, or if there is only one match), Processor B 152B may issue and transmit a notification to a user (i.e., to a device of that user) of the multi-layer lock system 150, via a display coupled to or in communication with the multi-layer lock system 150. Processor B 152B may also send the notification via email, text-messaging, or any other communication means now-known or later-developed. As alluded to above, the notification may indicate the authentication failure or the intrusion attempt to the user. Further, the notification indicating the authentication failure may also be sent to the user device that generated the data or data access request (i.e., requesting device). If keys matching both Key Y₁ and Key X_{N} are present, the data or data access request may be transmitted to data loader 130 via Internal Communication Interface 159. Data loader 130 may process the received data or data access request to access or modify data stored in the critical system(s) 110. In some embodiments, a notification indicating successful authentication or access granted may also be sent to the user (i.e., to a device of that user) of the multi-layer lock system 150.

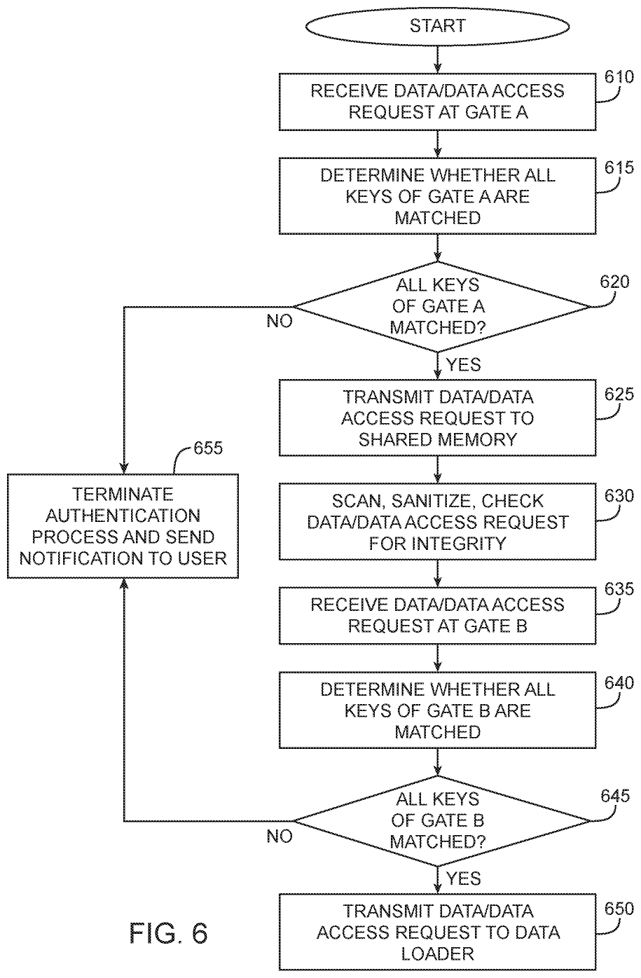

FIG. 6 is a flowchart illustrating an exemplary method of performing layered authentication processes by the multi-layer lock system 150 depicted in FIG. 5. At step 610, data or a data access request may be received at Gate A 150A. At step 615, Processor A 152A of Gate A 150A may determine whether all keys of Gate A 150A are matched by the data or data access request. At step 620, if all keys are not matched, the method proceeds to step 655, where the authentication process may be terminated and Processor A 152A of Gate A 150A may send a notification (of failure or intrusion attempt) to the user (i.e., to a device of that user) of the multi-layer lock system 150. Further, the notification indicating the authentication failure may also be sent to the user device that generated the data or data access request (i.e., requesting device). If all keys are matched, the method proceeds to step 625. At step 625, the data or data access request may be transmitted and stored in shared memory A 158A. At step 630, the data or data access request stored in the shared memory A 158A may be scanned, sanitized, or checked for integrity. At step 635, the data or data access request may be received at Gate B 150B. At step 640, Processor B 152B of Gate B 150B may determine whether all keys of Gate B 150B are matched by the data or data access request. At step 645, if all keys are not matched, the method proceeds to step 655, where the authentication process may be terminated and Processor B 152B of Gate B 150B may send a notification (of failure or intrusion attempt) to the user (i.e., to a device of that user) of the multi-layer lock system 150. Further, the notification indicating the authentication failure may also be sent to the user device that generated the data or data access request (i.e., requesting device). If all keys are matched, the method proceeds to step 650. At step 650, the data or data access request may be transmitted to data loader 130, which may be coupled or in communication with critical system(s) 110 and may access, retrieve, and/or modify critical data stored in the critical system(s) 110 in accordance with the data or data access request. In some embodiments, a notification indicating successful authentication or access granted may be sent to the user (i.e., to a device of that user) of the multi-layer lock system 150 and/or to the user device that generated the data or data access request (i.e., requesting device).

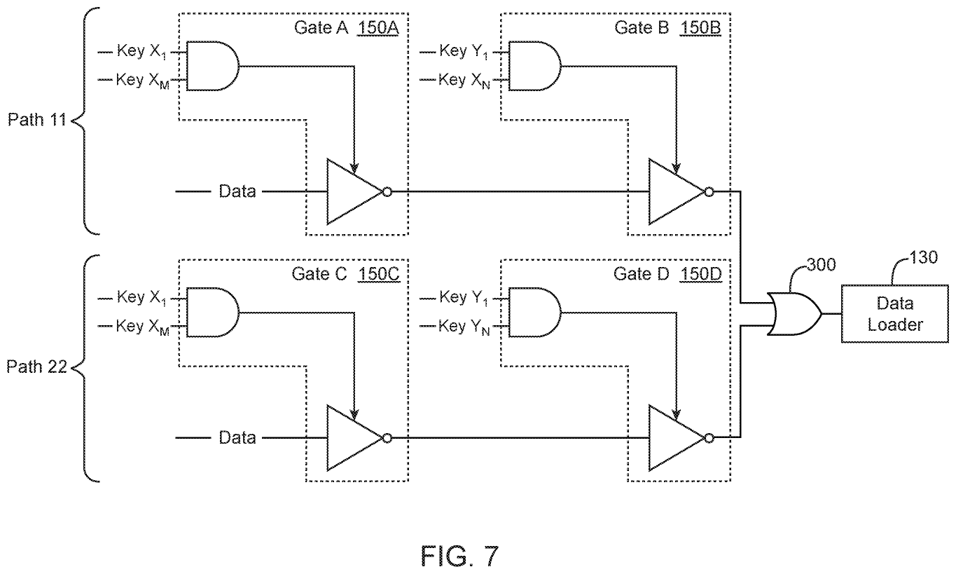

FIG. 7 is a concept diagram illustrating another exemplary design of the multi-layer lock system 150. In general, FIG. 7 depicts multiples gates (i.e., Gate A 150A , Gate B 150B, Gate C 150C, and Gate D 150D) arranged in multiple paths (i.e., Path 11 and Path 22). For example, Path 11 comprises Gate A 150A and Gate B 150B in series, and may be equivalent to the design illustrated in FIG. 4. For even more protection, Path 22 comprising Gate C 150C and Gate D 150D in series may be added as a separate, independent secure pathway for data and data access requests. Each of Gate C 150C and Gate D 150D may comprise a combination of keys that are different from the other, and that are also different from the combination keys included in each of Gate A 150A and Gate B 150B in Path 11. Therefore, the multi-layer lock system 150 may comprise multiple paths, with each path comprising multiple gates of different key combinations. In some embodiments, however, the key combinations required by some of the gates may be the same as those of certain other gates. Regardless, one of ordinary skill in the art will understand that the key combinations assigned to the gates are highly customizable and may be tailored based on user/consumer/market needs (e.g., based on the level of protection/security needed). As discussed above in reference to FIG. 4, both keys of each gate must be matched (i.e., keys ANDed together) in order for the data or data access requests to be authenticated and to pass through the gate. Path 11 and Path 22 may eventually be ORed at point 300, meaning a successful passage through at least one of the two paths, Path 11 and Path 22, may suffice for the data or data access request to be “fully” authenticated for transmission to data loader 130. Table 1 below shows possible overall authentication results based on the results of the authentication processes of Path 11 and Path 22 as illustrated in FIG. 7.

TABLE 1

| | | | | |
|---|---|---|---|---|
| Path 11 result | Failure | Success | Failure | Success |
| Path 22 result | Failure | Failure | Success | Success |
| Overall Result | Failure | Success | Success | Success |

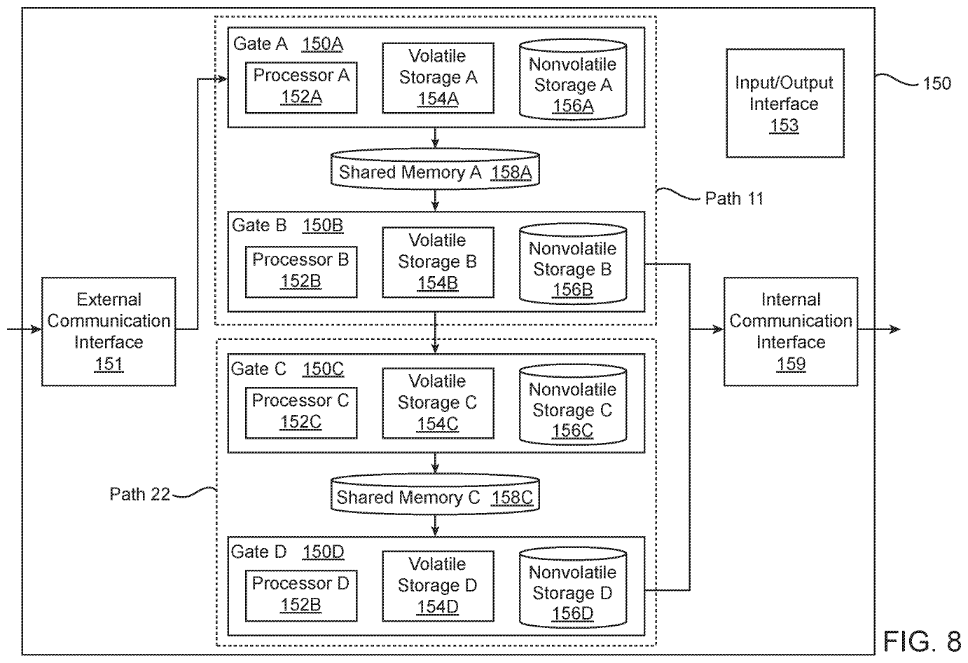

FIG. 8 is a block diagram illustrating exemplary components of the multi-layer lock system 150 designed in accordance with the concept diagram of FIG. 7. In general, FIG. 7 depicts External Communication Interface 151, Gate A 150A, Shared Memory A 158A, Gate B 150B, Gate C 150C, Shared Memory C 158C, Gate D 150D, and Internal Communication Interface 159. The arrows in FIG. 7 indicates the flow and/or direction of the data or data access request received at the multi-layer lock system 150, along the multiple components embodied therein. First, the data or data access request from a user device (e.g., any of the user devices 20A-20E in FIG. 1) may be received by External Communication Interface 151. The received data or data access request may then be transmitted/forwarded to Gate A 150A, to initiate a set of authentication processes implemented by Path 11.

As discussed above with reference to FIG. 5, Nonvolatile Storage A 156A of Gate A 150A may store the cybersecurity software or computer instructions corresponding to Gate A 150A (i.e., cybersecurity software or computer instructions implementing the Gate A 150A design illustrated in FIG. 7), which may be loaded and executed by Processor A 152A and Volatile Storage A 154A. Nonvolatile Storage A 156A may further store Key X₁ and Key X_{M} of Gate A 150A. Using Processor A 152A, Volatile Storage A 154A, and Nonvolatile Storage A 145A, the received data or data access request may be analyzed to determine whether keys matching Key X₁ and Key X_{M} are present. If keys matching both Key X₁ and Key X_{M} are not present (e.g., if there is no match, or if there is only one match), Processor A 152A may issue and transmit a notification to a user (i.e., to a device of that user) of the multi-layer lock system 150, via a display coupled to or in communication with the multi-layer lock system 150. Processor A 152A may also send the notification via email, text-messaging, or any other communication means now-known or later-developed. As alluded to above, the notification may indicate the authentication failure or the intrusion attempt to the user. Further, the notification indicating the authentication failure may also be sent to the user device that generated the data or data access request (i.e., requesting device). In some embodiments, Processor A 152A may not issue any notification. Then, the data or data access request may be transmitted to Gate C 150C of Path 22, and the authentication processes of Path 11 may be terminated.

If keys matching both Key X₁ and Key X_{M} of Gate A 150A are present, the data or data access request may be transmitted/stored in Shared Memory A 158A, where the data or data access request may be scanned, sanitized, and checked for integrity before being transmitted to Gate B 150B. In another embodiment, Shared Memory A 158A may not be implemented and the data or data access request may be transmitted directly to Gate B 150B. In yet another embodiment, Shared Memory A 158A may be present but the data or data access request may bypass Shared Memory A 158A and may be transmitted directly to Gate B 150B. Once the data or data access request is received at Gate B 150B, cybersecurity software or computer instructions corresponding to Gate B 150B (i.e., cybersecurity software or computer instructions implementing the Gate B 150B design illustrated in FIG. 7) stored in Nonvolatile Storage B 154B may be loaded and executed by Processor B 152B and Volatile Storage B 154B. Nonvolatile Storage B 154B may further store Key Y₁ and Key X_{N} of Gate B 150B. Using Processor B 150B, Volatile Storage B 154B, and Nonvolatile Storage B 156B, the received data or data access request may be analyzed to determine whether keys matching Key Y₁ and Key X_{N} are present. If keys matching both Key Y₁ and Key X_{N} are not present (e.g., if there is no match, or if there is only one match), Processor B 152B may issue and transmit a notification to a user (i.e., to a device of that user) of the multi-layer lock system 150, via a display coupled to or in communication with the multi-layer lock system 150. Processor B 152B may also send the notification via email, text-messaging, or any other communication means now-known or later-developed. As alluded to above, the notification may indicate the authentication failure or the intrusion attempt to the user. Further, the notification indicating the authentication failure may also be sent to the user device that generated the data or data access request (i.e., requesting device). In some embodiments, Processor B 152B may not issue any notification. Then, the data or data access request may be transmitted to Gate C 150C of Path 22, and the authentication processes of Path 11 may be terminated. On the other hand, if keys matching both Key Y₁ and Key X_{N} of Gate B 150B are present, the data or data access request may be transmitted to the data loader 130 via Internal Communication Interface 159. In some embodiments, a notification indicating successful authentication or access granted may also be sent to the user (i.e., to a device of that user) of the multi-layer lock system 150 and/or to the user device that generated the data or data access request (i.e., requesting device). As alluded to above, due to the implementation of the OR gate (i.e., point 300 in FIG. 7), passing the authentication processes of Path 11 may suffice for the data or data access request to be transmitted to data loader 130, regardless of the result of the authentication processes of Path 22.

If the data or data access request fails the authentication process of either Gate A 150A or Gate B 150B (i.e., both keys of either Gate A 150A or Gate B 150B are not matched), the data or data access request may be transmitted to Gate C 150C of Path 22. At Gate C 150C, Nonvolatile Storage C 156C may store the cybersecurity software or computer instructions corresponding to Gate C 150C (i.e., cybersecurity software or computer instructions implementing the Gate C 150C design illustrated in FIG. 7), which may be loaded and executed by Processor C 152C and Volatile Storage C 154C. Nonvolatile Storage C 156C may further store Key X₁ and Key X_{M} of Gate C 150C. Using Processor C 152C, Volatile Storage C 154C, and Nonvolatile Storage C 145C, the received data or data access request may be analyzed to determine whether keys matching Key X₁ and Key X_{M} are present. If keys matching both Key X₁ and Key X_{M} are not present (e.g., if there is no match, or if there is only one match), the authentication processes of Path 22 may be terminated. Further, Processor C 152C may issue and transmit a notification to a user (i.e., to a device of that user) of the multi-layer lock system 150, via a display coupled to or in communication with the multi-layer lock system 150. Processor C 152C may also send the notification via email, text-messaging, or any other communication means now-known or later-developed. As alluded to above, the notification may indicate the authentication failure or the intrusion attempt to the user. Further, the notification indicating the authentication failure may also be sent to the user device that generated the data or data access request (i.e., requesting device).

If keys matching both Key X₁ and Key X_{M} of Gate C 150C are present, the data or data access request may be transmitted/stored in Shared Memory C 158C, where the data or data access request may be scanned, sanitized, and checked for integrity before being transmitted to Gate D 150D. In another embodiment, Shared Memory C 158C may not be implemented and the data or data access request may be transmitted directly to Gate D 150D. In yet another embodiment, Shared Memory C 158C may be present but the data or data access request may bypass Shared Memory C 158C and may be transmitted directly to Gate D 150D. Once the data or data access request is received at Gate D 150D, cybersecurity software or computer instructions corresponding to Gate D 150D (i.e., cybersecurity software or computer instructions implementing the Gate D 150D design illustrated in FIG. 7) stored in Nonvolatile Storage D 154D may be loaded and executed by Processor D 152D and Volatile Storage D 154D. Nonvolatile Storage D 154D may further store Key Y₁ and Key Y_{N} of Gate D 150D. Using Processor D 150D, Volatile Storage D 154D, and Nonvolatile Storage D 156D, the received data or data access request may be analyzed to determine whether keys matching Key Y₁ and Key Y_{N} are present. If keys matching both Key Y₁ and Key Y_{N} are not present (e.g., if there is no match, or if there is only one match), the authentication processes of Path 22 may be terminated. Further, Processor D 152D may issue and transmit a notification to a user (i.e., to a device of that user) of the multi-layer lock system 150, via a display coupled to or in communication with the multi-layer lock system 150. Processor D 152D may also send the notification via email, text-messaging, or any other communication means now-known or later-developed. As alluded to above, the notification may indicate the authentication failure or the intrusion attempt to the user. Further, the notification indicating the authentication failure may also be sent to the user device that generated the data or data access request (i.e., requesting device).

If keys matching both Key Y₁ and Key Y_{N} of Gate D 150D are present, the data or data access request may be transmitted to the data loader 130 via Internal Communication Interface 159. In some embodiments, a notification indicating successful authentication or access granted may also be sent to the user (i.e., to a device of that user) of the multi-layer lock system 150 and/or to the user device that generated the data or data access request (i.e., requesting device). As alluded to above, due to the implementation of the OR gate (i.e., point 300 in FIG. 7), passing the authentication processes of Path 22 may suffice for the data or data access request to be transmitted to data loader 130 via Internal Communication Interface 159, regardless of the result of the authentication processes of Path 11.

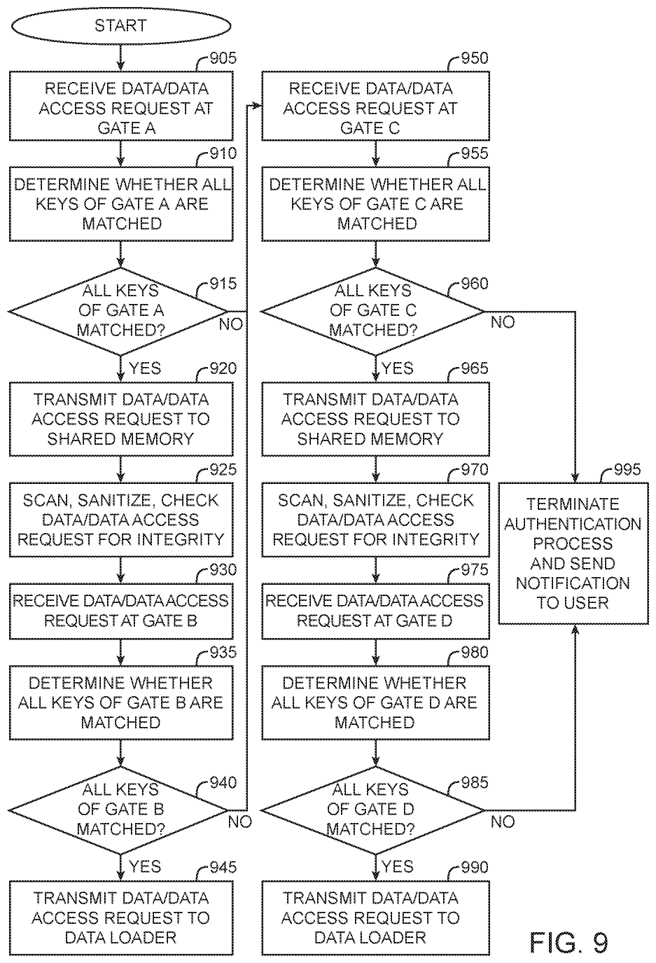

FIG. 9 is a flowchart illustrating an exemplary method of performing layered authentication processes by the multi-layer lock system 150 depicted in FIG. 8. At step 905, data or a data access request may be received at Gate A 150A of Path 11. At step 910, Processor A 152A of Gate A 150A may determine whether all keys of Gate A 150A are matched by the data or data access request. At step 915, if all keys are not matched, the method proceeds to step 950, where the data or data access request may be transmitted and received at Gate C 150C of Path 22 for further authentication. If all keys are matched, the method proceeds to step 920. At step 920, the data or data access request may be transmitted and stored in shared memory A 158A. At step 925, the data or data access request stored in the shared memory A 158A may be scanned, sanitized, or checked for integrity. At step 930, the data or data access request may be received at Gate B 150B. At step 935, Processor B 152B of Gate B 150B may determine whether all keys of Gate B 150B are matched by the data or data access request. At step 940, if all keys are not matched, the method proceeds to step 950, where the data or data access request may be transmitted and received at Gate C 150C of Path 22 for further authentication. If all keys are matched, the method proceeds to step 945. At step 945, the data or data access request may be transmitted to data loader 130, which may be coupled to or in communication with critical system(s) 110 and may access, retrieve, and/or modify critical data stored in the critical system(s) 110 in accordance with the data or data access request. In some embodiments, a notification indicating successful authentication or access granted may also be sent to the user (i.e., to a device of that user) of the multi-layer lock system 150 and/or to the user device that generated the data or data access request (i.e., requesting device).

At step 950, the data or data access request (i.e., the data or data access request that failed the authentication process of Path 11) may be received at Gate C 150C of Path 22. At step 955, Processor C 152C of Gate C 150C may determine whether all keys of Gate C 150C are matched by the data or data access request. At step 960, if all keys are not matched, the method proceeds to step 995, where the authentication process may be terminated and Processor C 152C of Gate C 150C may send a notification (of failure or intrusion attempt) to the user (i.e., to a device of that user) of the multi-layer lock system 150. Further, the notification indicating the authentication failure may also be sent to the user device that generated the data or data access request (i.e., requesting device). If all keys are matched, the method proceeds to step 965. At step 965, the data or data access request may be transmitted and stored in shared memory C 158C. At step 970, the data or data access request stored in the shared memory C 158C may be scanned, sanitized, or checked for integrity. At step 975, the data or data access request may be received at Gate D 150D. At step 980, Processor D 152D of Gate D 150D may determine whether all keys of Gate D 150D are matched by the data or data access request. At step 985, if all keys are not matched, the method proceeds to step 995, where the authentication process is terminated and Processor D 152D of Gate D 150D may send a notification (of failure or intrusion attempt) to the user (i.e., to a device of that user) of the multi-layer lock system 150. Further, the notification indicating the authentication failure may also be sent to the user device that generated the data or data access request (i.e., requesting device). If all keys are matched, the method proceeds to step 990. At step 990, the data or data access request may be transmitted to data loader 130, which may be coupled to or in communication with critical system(s) 110 and may access, retrieve, and/or modify critical data stored in the critical system(s) 110 in accordance with the data or data access request. In some embodiments, a notification indicating successful authentication or access granted may also be sent to the user (i.e., to a device of that user) of the multi-layer lock system 150 and/or to the user device that generated the data or data access request (i.e., requesting device).

It is to be understood that the diagrams provided herein are merely exemplary, and the design of the multi-layer lock system 150 of the present disclosure is highly flexible and customizable. For instance, a person of ordinary skill in the art will understand that the keys of each gate may be ORed (instead of ANDed), meaning just one of the keys may be required to unlock the gate. Further, a person of ordinary skill in the art will understand that the paths (e.g., Path 11 and Path 22) may be ANDed (instead of ORed), meaning the authentication processes of both paths must be successfully completed to gain access to data loader 130. Further, it should be appreciated that the number of gates, keys, paths, and the manner in which they are interconnected and interoperate, may be configurable and customizable. Further, the multi-layer lock system 150 may allow for multiple configurable levels of access, such as, e.g., Read only, Read and Write, Write only, one-way interaction, two-way interaction, etc. Access levels may be configurable such that different levels of access may be granted based on the results of the authentication processes implemented by various gates and paths. For example, if all of the gates in the multi-layer lock system 150 have been successfully “unlocked,” both Read and Write may be allowed. On the other hand, if only some of the gates in the multi-layer lock system 150 have been “unlocked,” only Read may be allowed. One of ordinary skill in the art will recognize that the level of access granted may be configured in various ways, and may not be limited to the exemplary configurations specifically discussed herein. Access levels many be pre-configured and may be periodically updated/changed via software update. Also, a user of the multi-layer lock system 150 may configure the access levels via I/O interface (for example, by selecting options on a menu screen presented via connected and/or built-in display) or communication interface (for example, by selecting options on a menu screen presented via a mobile device connected using Bluetooth, Ethernet, cable, Wi-Fi, etc.) discussed above with reference to FIG. 3.

Embodiments of the present disclosure concerning data access authentication using multi-layer lock system addresses the drawbacks of the prior approaches, using some of the techniques discussed above. In general, the multi-layer lock system in accordance with the embodiments of the present disclosure has at least the following distinguishable features that lead to significant technical improvements in the fields of cybersecurity, data integrity, database management, and cloud and distributed computing:

1) layered, dissimilar security measures enable heightened level of protection;

2) unknown combinations of dissimilar software and hardware hamper unauthorized access attempts more effectively;

3) hardware/software combinations and arrangement of the security measures are customizable based on the market being served;

4) can be developed as a standalone device or as a component of an existing system; and

5) can be integrated with various systems and environments.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable storage medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

What is claimed is:

1. A multi-layer cybersecurity system for restricting data access, comprising:
a first computer system executing a first set of instructions to operate a first security layer, the first set of instructions causing the first computer system to:
receive a data access request from a requesting device;
determine whether a first set of keys are matched by the data access request; and
decline the data access request and send a notification to a user device based on determining the first set of keys are not matched; and
a second computer system executing a second set of instructions written in a programming language different from that of the first set of instructions to operate a second security layer, the second set of instructions causing the second computer system to:
receive the data access request from the first security layer based on the first computer system determining the first set of keys are matched;
determine whether a second set of keys are matched by the data access request; and
decline the data access request and send a notification to the user device based on determining the second set of keys are not matched.

2. The multi-layer lock system of claim 1, wherein the second set of instructions further cause the second computer system to:
authenticate the data access request based on determining the second set of keys are matched; and
transmit the data access request to a data loader in communication with a critical system.

3. The multi-layer cybersecurity system of claim 2, wherein the multi-layer cybersecurity system is:
integrated with the data loader; or
a standalone device in communication with the data loader.

4. The multi-layer cybersecurity system of claim 1, wherein the first computer system comprises a first processor and the second computer system comprises a second processor, the first processor being different from the second processor.

5. The multi-layer cybersecurity system of claim 1, further comprising:
an input/output interface configured to send the notification to a display.

6. The multi-layer cybersecurity system of claim 5, wherein the display is at least one or more of:
built-in; and
connected via input/output interface.

7. The multi-layer cybersecurity system of claim 1, wherein the data access request comprises keys to be matched to the first set of keys and the second set of keys.

8. The multi-layer cybersecurity system of claim 1, further comprising:
at least one shared memory coupled to the first computer system and to the second computer system.

9. The multi-layer cybersecurity system of claim 8, wherein the data access request from the first security layer is stored at the at least one shared memory before being received at the second security layer.

10. The multi-layer cybersecurity system of claim 9, wherein the data access request is at least one or more of scanned, sanitized, and checked for integrity by the at least one shared memory.

11. A computer-implemented method of restricting data access using a multi-layer cybersecurity system comprising a first computer system and a second computer system, the computer-implemented method comprising:
by the first computer system executing a first set of instructions to operate a first layer,
receiving a data access request from a requesting device,
determining whether a first set of keys are matched by the data access request, and
declining the data access request and sending a notification to a user device based on determining the first set of keys are not matched; and
by the second computer system executing a second set of instructions written in a programming language different from that of the first set of instructions to operate a second security layer,
receiving the data access request from the first security layer based on the first computer system determining the first set of keys are matched,
determining whether a second set of keys are matched by the data access request, and
declining the data access request and sending a notification to the user device based on determining the second set of keys are not matched.

12. The computer-implemented method of claim 11, further comprising:
by the second computer system,
authenticating the data access request based on determining the second set of keys are matched, and
transmitting the data access request to a data loader in communication with a critical system.

13. The computer-implemented method of claim 12, wherein the multi-layer lock system is integrated with the data loader.

14. The computer-implemented method of claim 11, wherein the first computer system comprises a first processor and the second computer system comprises a second processor, the first processor being different from the second processor.

15. The computer-implemented method of claim 11, wherein the multi-layer cybersecurity system further comprises at least one shared memory and the data access request is at least one or more of scanned, sanitized, and checked for integrity by the at least one shared memory before being received at the second security layer.

16. A non-transitory computer readable medium storing instructions that, when executed by one or more processors, cause the one or more processors to perform a method of restricting data access using a multi-layer cybersecurity system comprising a first computer system and a second computer system, the method comprising:
by the first computer system executing a first set of instructions to operate a first layer,
receiving a data access request from a requesting device,
determining whether a first set of keys are matched by the data access request, and
declining the data access request and sending a notification to a user device based on determining the first set of keys are not matched; and
by the second computer system executing a second set of instructions written in a programming language different from that of the first set of instructions to operate a second security layer,
receiving the data access request from the first security layer based on the first computer system determining the first set of keys are matched,
determining whether a second set of keys are matched by the data access request, and
declining the data access request and sending a notification to the user device based on determining the second set of keys are not matched.

17. The non-transitory computer readable medium of claim 16, wherein the method further comprises:
by the second computer system,
authenticating the data access request based on determining the second set of keys are matched, and
transmitting the data access request to a data loader in communication with a critical system.

18. The non-transitory computer readable medium of claim 17, wherein the multi-layer cybersecurity system is integrated with the data loader.

19. The non-transitory computer readable medium of claim 16, wherein the first computer system comprises a first processor and the second computer system comprises a second processor, the first processor being different from the second processor.

20. The non-transitory computer readable medium of claim 16, wherein the multi-layer cybersecurity system further comprises at least one shared memory and the data access request is at least one or more of scanned, sanitized, and checked for integrity by the at least one shared memory before being received at the second security layer.
